(19) United States
(12) Patent Application Publication
(10) Pub. No.: US 2006/0191743 A1
(43) Pub. Date: Aug. 31, 2006

(54) Sound absorbing wall systems and methods of producing same

(76) Inventors: Clinton W. Pike SR., Cypress, TX (US); Patrick E. Allard, Gainesville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/552,188

(22) PCT Filed: Apr. 7, 2004
(86) PCT No.: PCT/US04/10703

§ 371 Date: Oct. 6, 2005

Related U.S. Application Data
(60) Provisional application No. 60/460,974, filed on Apr. 7, 2003.

(30) Foreign Application Priority Data
Apr. 6, 2004 (US) 10/818822

(51) Int. Cl. E04B 1/82; E04B 1/84; G10K 11/16

(52) U.S. Cl. 181/290; 181/294; 181/296

(57) ABSTRACT

Sound absorbing wall systems are disclosed that include a wallboard material and a soundproofing material adhered to the wallboard material. Also disclosed are methods for producing sound absorbing wall systems, one method including adhering a soundproofing material to a wallboard material. With the method, the soundproofing material adhered to the wallboard material can be directly installed in homes and/or buildings as wallboard.

### CLAIM OF PRIORITY

This application claims priority to copending U.S. provisional application entitled, “Sound Absorbing Wall Systems And Methods Of Producing Same,” having Ser. No. 60/460,974, filed Apr. 7, 2003, which is entirely incorporated herein by reference.

### BACKGROUND

1. Field of the Invention

The present disclosure is generally related to sound absorbing wall systems and methods of producing the same.

2. Description of Related Art

Soundproofing of most rooms in residential and commercial applications has traditionally required separate installation of soundproofing material from the drywall or other interior product that is typically fastened to studs or frames in homes or buildings. For example, to make a soundproof wall, the soundproofing material was first fastened to the studs, and then plywood or drywall material was added to the soundproofing material. One disadvantage of such a soundproofing system occurs when the frames or studs to which the soundproofing material was attached was subjected to vibrations. The soundproofing material moved separately from the drywall and/or plywood, causing cracks in the drywall at the joints where it was mated or between the ceiling and wall, or the wall and the floor. Further, by installing a separate soundproofing system than the drywall or plywood, at least one additional step was required in the construction of the wall, thus adding to material, labor, costs, and time.

Other soundproofing systems have added the soundproofing material to the outside of the finished drywall. This also adds at least another step in the wall construction process, also adding to material, labor, costs, and time. Additionally, such systems usually had to use special wall construction techniques or devices in order to support the additional soundproofing material.

U.S. Pat. No. 4,719,730 issued to Winkowski ('730 patent) discloses a partition wall with laminated panels hung from a wall framework by clips applied to the back of the panel. The panels consist of conventional gypsum base board to which a rigid, high density glass fiber core board is adhered with adhesive beads. The glass fiber core board has adhered thereover an acoustical transparent, thin, decorative wall face surface laminate bonded to the surface of the core board and the gypsum board edges. The panels of the '730 patent, however, require specific suspension assemblies to affix the panels to metal studs in the building, complicating the procedure and adding to labor and costs of installing the sound absorptive tack board.

### SUMMARY

Embodiments herein provide sound absorbing wall systems and methods of producing the same. One embodiment of a sound absorbing wall system includes a wallboard material and a soundproofing material adhered to the wallboard material. Briefly described, one embodiment of a method of producing the sound absorbing wall system includes adhering a soundproofing material to a wallboard material.

### BRIEF DESCRIPTION OF THE DRAWINGS

Many aspects of the sound absorbing wall systems and methods of producing the same can be better understood with reference to the following drawings. The components in the drawings are not necessarily to scale. Moreover, like reference numerals designate corresponding parts throughout the several views.

FIG. 1 is a side view of a portion of one embodiment of the disclosed sound absorbing wall systems.

FIG. 2 is a side view of one embodiment of disclosed systems used to produce the sound absorbing wall system of FIG. 1.

### DETAILED DESCRIPTION

As identified in the foregoing, sound absorbing wall systems and methods for producing them may be difficult and costly to make and/or install. Additionally, sound absorbing wall systems may leave the outer surface of the wall with a textured or decorative finish that may not be finished, or at least may not be finished in the same manner as gypsum-based, plywood, or other wallboard material. Therefore, needed are sound absorbing wall systems that can be installed and finished the same as gypsum-based wallboard.

Disclosed herein are sound absorbing wall systems and systems and methods of producing the sound absorbing wall systems. The disclosed sound absorbing wall systems can be installed the same as gypsum-based wallboard, without the need for special tools or devices for affixing the panels of the system to studs or frames in the home or building in which it is being installed. Additionally, the sound absorbing wall systems can be finished the same as gypsum-based wallboard, e.g., wallpapered, painted, textured, etc. The disclosed methods for making improved sound absorbing wall systems provide a process that is efficient and economical in operation and can be performed by, for example, manufacturers of gypsum-based wallboard, plywood boards, and/or manufacturers of soundproofing material, as an additional step in their production.

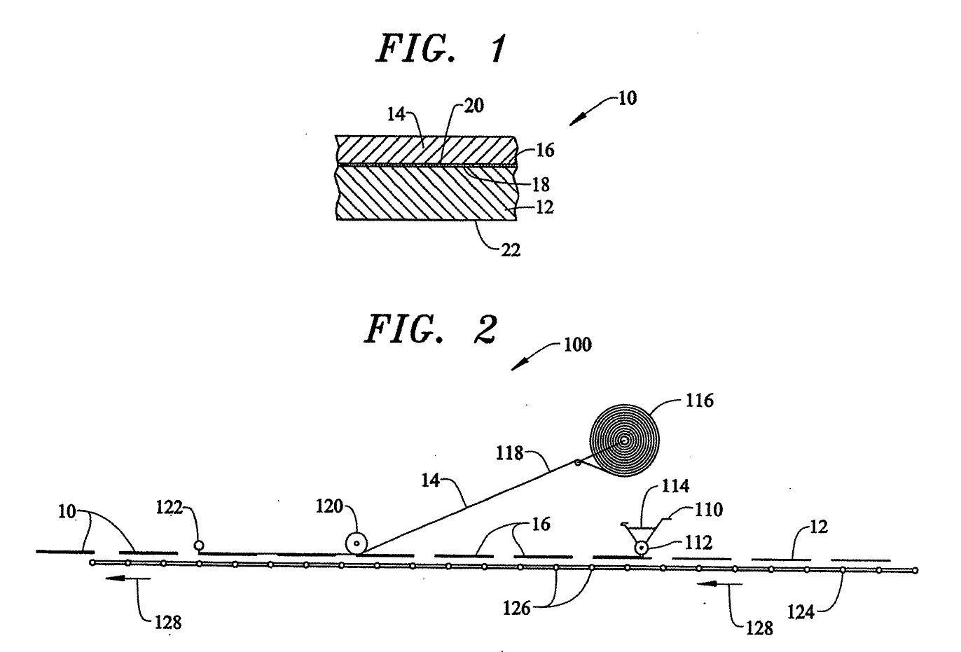

Reference will now be made to the drawings. In FIG. 1 is a side view of an exemplary embodiment of a sound absorbing wall system 10. The system of FIG. 1 includes a wallboard material 12, with a layer of soundproofing material 14 adhered thereto with an adhesive 16. The adhesive 16 can be absorbed into the wallboard material 12 and/or the soundproofing material 14, but has been shown in FIG. 1 as a separate layer, for purposes of illustration. The adhesive can be applied to either the inner face 18 of the wallboard material 12, or the inner face 20 of the soundproofing material 14. Preferably, the outer face 22 of the wallboard material 12 is the outer wall of the sound absorbing wall system 10.

The wallboard material 12 can be, for example, a gypsum-based wallboard, plywood, cementitious, wood composite, fiberglass or any wallboard used to finish walls, ceilings and/or floors in homes and/or buildings. For example, the wallboard 12 can be any gypsum-based wallboard manufactured by and commercially available from manufacturers such as National Gypsum Company in Charlotte, N.C., USA; USG of Chicago, Ill., USA; and/or Georgia Pacific Corporation of Atlanta, Ga., USA. An exemplary wallboard material 12 is approximately one-eighth (⅛) to three quarters (¾) inch. Preferably, the wall board material is about three-eighths (⅜) to five-eighths (⅝) inch thick. More preferably, the wallboard material 12 is approximately one-half (½) inch thick.

The soundproofing material 14 can be, for example, any sound-absorbing or sound-dampening material that is preferably lightweight and is able to be adhered to the wallboard material 12. The preferred soundproofing material is resistant to degradation by inorganic acids, organic acids, reducing agents, detergent solutions, alcohols, aliphatic hydrocarbons, mineral oil, amines, and aldehydes. Additionally, in some embodiments, the soundproofing material 14 can have as its characteristics, or have fillers that lend it the characteristics of, being waterproof, vaporproof and/or resistant to mold and/or mildew. Further, in one exemplary embodiment, the soundproofing material 14 can be cut with any tool used to cut gypsum-based drywall. For example, the soundproofing material 14 can be any polyvinyl chloride (PVC) sound control material. A specific example of the soundproofing material 14 is a high density PVC sound control material manufactured by and commercially available as UltraBloc™ from Pandel, Inc. of Cartersville, Ga., USA as a laminate. The soundproofing material 14 reflects sound and, ideally, prevents it from being transmitted through the soundproofing material 14.

Fillers can also be added that increase the sound-reduction capability of the soundproofing material 14, so long as the fillers do not unduly increase the weight of the soundproofing material 14 or cause handling problems. Fillers can be added to impart strength and toughness to the PVC and to improve the PVC resistance to tearing, abrasion, flex fatigue, and also to increase durability. Additionally, fillers can be added to improve the processibility of the PVC, as well as function as a viscosity repressant or depressant, a heat stabilizer, a fire retardant, and as a cheaper replacement for the more expensive PVC. Examples of fillers that can be used include the following: diisononyl phthlate (DNP); 2-2-4 trimethyl 1,3-pentadioldiisobutyrate (TXIB); medium-high volatile aliphatic hydrocarbons such as Viscobyk® −4010, −4013, −4015, −4040, −5025, −5050 for a viscosity depressant or repressant; Plastistab®−2000, −2372, −2801, −2802, −2805, −2808, and/or −2809 for a metal heat stabilizer (e.g., Ca, Ba, Zn); carbon black and/or silica; PVC plasticizer, e.g., OXY™ 6338 or Borden® 260ss; aluminum trihydroxide as a fire retardant; calcium carbonate and/or flyash filler; and calcium oxide, such as Quicklime.

An exemplary soundproofing material 14 is approximately one-eighth (⅛) to one-quarter (¼) inch thick. Preferably, the soundproofing material 14 is approximately one-quarter (¼) inch thick. In one exemplary embodiment, the soundproofing material 14 is a laminate that is applied to the wallboard material 12.

The adhesive 16 is any adhesive or glue that is able to bond the soundproofing material 14 to the wallboard material 12. The adhesive 16, in addition to initially adhering the soundproofing material 14 to the wallboard material 12, prevents the soundproofing material 14 from de-laminating in handling, shipping, installation, and use during the life of the sound absorbing wall system 10. In particular, the adhesive 16 is preferably any adhesive formulated to adhere to drywall paper coating used on gypsum-based drywall board. For example, adhesives that can be used include polyurethane adhesives and adhesives that are used to bond expandable polystyrene (EPS) to wallboard. For example, adhesive 16 can be/include an acrylic polymer. The acrylic polymer can function as a binder for non-cementitious materials. The adhesive 16 can impart good water resistance, adhesion, and durability. Additionally, the adhesive 16 can provide good color fastness, resistance to yellowing, and good resistance to chalking. In addition, the adhesive 16 desirably has a good resistance to dirt. An example of a specific adhesive 16 that can be used includes, but is not limited to, an acrylic polymer such as Rhoplex® EI-8764, manufactured by, and commercially available from, Rohm & Haas, France, S.A. in Paris, France. The Rhoplex® EI-8764 acrylic polymer is suited for application as the adhesive 16, due to its characteristics. Such characteristics include a solids content of approximately 60.0 to 61.0% by weight; a pH of approximately 8.9 to 9.7; a viscosity of approximately 400 to 1500 centipoises (cps); a glass transition temperature of approximately 12 to 14° C.; and an anionic emulsifier charge.

Methods of producing the sound absorbing wall systems are also disclosed. An exemplary embodiment of a method for making the sound-absorbing wall system includes adhering the soundproofing material 14 to the wallboard material 12. Shown in FIG. 2 is an illustration of an exemplary system 100 used to practice the disclosed method. In the system 100, an adhesive dispensing device 110 dispenses the adhesive 16 onto the wallboard material 12. The exemplary adhesive dispensing device 110 includes a roller 112 that smoothes the adhesive 16 onto the wallboard 12 dispensed from a reservoir 114.

With the adhesive 16 applied to the wallboard, the soundproofing material 14 is applied to the wallboard material 12. For example, as shown in FIG. 2, a roll 116 of the soundproofing material 14 can be unrolled over the wallboard material 12. Preferably, the soundproofing material 14 of the roll 116 is approximately the same width of the wallboard material 12 onto which it is being adhered. An optional tensioner 118 can be disposed on or near the roll 116 to provide the appropriate amount of tension on the roll 116 as the soundproofing material 14 is being paid off the roll 116. Additionally, an optional mating roll 120 can be placed at the point of contact between the wallboard material 12 and the soundproofing material 14 to urge the soundproofing material 14 into tight contact with the wallboard material 12.

A wire or roll cutter 122 cuts the soundproofing material 14 to a length that is approximately equivalent to the length of the wallboard material 12. The wallboard 12 can be precut to a predetermined length before the soundproofing material 14 is adhered thereto, or it can be cut at the same time as the roll cutter 122 cuts the soundproofing material 14. The system 100 can also include an optional rolling conveyor belt 124, moved by rolls 126 in the direction of arrows 128. The conveyor belt 124 moves the wallboard material 12 through the assembly process of the sound absorbing wall systems 10.

The sound absorbing wall system 10 can be installed and used in numerous building applications utilizing drywall fastening and installation systems, thereby producing a sound absorbing wall system in a room or building. Drywall screws used to install gypsum-based wallboards, ranging from approximately one to two inches, can be used to install the sound absorbing wall system 10. No special devices or configurations are necessary to produce a sound absorbing wall system in a building or room. The sound absorbing wall system 10 can be attached to metal or wood studs or frame of a building making the sound absorbing wall system 10 inexpensive and flexible. In this fashion, all ceilings and walls where gypsum-based drywall is used can be soundproofed using the sound absorbing wall system 10. For example, in residential houses, the floors reflect sound which can be absorbed by the walls and ceilings in which the sound absorbing wall system 10 has been installed. By further example, in multi-story houses or buildings, the ceiling below the area to be soundproofed can have the sound absorbing wall system 10 installed, further reducing outside noise. In apartment complexes or hotels, the walls between apartments and rooms, as well as all ceilings and/or floors with any apartment or room above or below, can be soundproofed using the sound absorbing wall system 10.

In one embodiment, when the sound absorbing wall system 10 is installed in a room, the soundproofing material 14 is disposed against the frame or studs of the room. Thus, the wallboard material 12 is exposed as the outer wall and can be finished in any manner as gypsum-based wallboard, or plywood, giving flexible design choices.

In one embodiment, the sound absorbing wall system 10 is lightweight. The sound absorbing wall system 10 can be, for example, less than approximately 90 lbs. per conventionally-sized sheet of drywall, without compromising the sound-absorbing characteristics of standard noise-reduction coefficients. Specifically, embodiments of the sound absorbing wall system 10 include a sound absorbing wall system 10 that is approximately 87 lbs. per conventionally-sized sheet of drywall.

It should be emphasized that the above-described embodiments of the sound absorbing wall systems and embodiments of methods for producing the sound absorbing wall systems are merely possible example implementations. Many variations and modifications can be made to the above-described embodiment(s). All such modifications and variations are intended to be included herein within the scope of this disclosure and protected by the following claims.

Therefore, having thus described the invention, at least the following is claimed:

1. A sound absorbing wall system, comprising:
a wallboard material; and
a soundproofing material adhered to the wallboard material.

2. The system of claim 1, wherein the soundproofing material is a laminate.

3. The system of claim 2, wherein the soundproofing laminate comprises a polyvinyl chloride composition.

4. The system of claim 1, wherein the soundproofing material is adhered to the wallboard material with an adhesive.

5. The system of claim 4, wherein the adhesive comprises an material chosen from at least one of a polyurethane, a silicone or an acrylic polymer.

6. The system of claim 1, further comprising studs,
wherein the wallboard material with the soundproofing material adhered thereto is affixed to the studs, with the soundproofing material abutting the studs.

7. The sound absorbing wall system of claim 1, wherein the sound absorbing wall system is less than about 90 lbs.

8. The sound absorbing wall system of claim 7, wherein the wallboard material is approximately the same length and width of drywall sheets installed in homes.

9. A method of producing a sound absorbing wall system, comprising:
adhering a soundproofing material to a wallboard material.

10. The method of claim 9, further comprising affixing the wallboard material with the soundproofing material adhered thereto to studs in a building.

11. The method of claim 9, wherein adhering the soundproofing material to the wallboard material comprises:
applying an adhesive to the wallboard material; and
applying the soundproofing material to the wallboard material with the adhesive disposed thereon.

12. The method of claim 11, wherein applying the soundproofing material to the wallboard material with the adhesive disposed thereon comprises:
unrolling a roll of the soundproofing material; and
applying the soundproofing material to the wallboard material with the adhesive disposed thereon.

13. The method of claim 12, further comprising urging the soundproofing material into tight contact with the wallboard material with the adhesive disposed thereon.

14. The method of claim 9, further comprising cutting the soundproofing material with the wallboard material adhered thereto into a predetermined shape.

15. The method of claim 9, further comprising installing the wallboard with the soundproofing material adhered thereto in a building by fastening the wallboard to a frame or studs in the building.

16. The method of claim 15, further comprising finishing an exposed outer surface of the sound absorbing wall system.

17. The method of claim 16, wherein finishing the exposed outer surface comprises at least one of: painting, plastering, wallpapering, texturizing, or decorating.
